(19) United States
(12) Patent Application Publication
(10) Pub. No.: US 2005/0234903 A1
(43) Pub. Date: Oct. 20, 2005

(54) Medical information management apparatus and method, and medical information management program

(75) Inventor: Yoshinobu Makino, Kaisei-machi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/100,454

(22) Filed: Apr. 7, 2005

(30) Foreign Application Priority Data
Apr. 16, 2004 (JP) 2004-121771

(51) Int. Cl. G06F 17/30

(52) U.S. Cl. 707/4; 707/102

(57) ABSTRACT

In a medical information management apparatus for managing contents of diagnoses and treatments as electronic medical sheet data, entries into outcome fields in the electronic medical sheets is automated or semi-automated and adjustment of disease/injury name fields is prompted. The medical information management apparatus includes a recording medium in which an electronic medical sheet database is recorded; an automatic outcome processing unit for retrieving electronic medical sheet data and adding outcome field data and/or end date data to the retrieved electronic medical sheet data when set condition is satisfied; a display data generating unit for generating display data for displaying contents of the medical sheets of respective cases based on the electronic medical sheet data of the plural cases accumulated in the database; and a display unit for displaying contents of the medical sheets based on the display data generated by the display data generating unit.

### BACKGROUND OF THE INVENTION

1. Field of the Invention

The present invention relates to a medical information management apparatus for managing contents of diagnoses and treatments as electronic medical sheet data in a medical institution. Further, the present invention relates to a medical information management method and a medical information management program to be used in such a medical information management apparatus.

2. Description of a Related Art

In medical institutions such as clinics and general hospitals, medical sheets (medical records or clinical charts), in which contents or contents of diagnoses and treatments are recorded, are required to be stored in order to know changes in medical condition of patients, and required to be stored in a predetermined period by law. Conventionally, chart forms (papers), in which descriptions of diagnoses and treatments are written with writing instruments, are stored, and therefore, securing of storage space, management work, retrieval work have imposed heavy burdens on the medical institutions.

On the other hand, in recent years, digitization in creation of medical sheets has been proceeding, and storage space can be reduced and management work and retrieval work can be saved by recording contents of diagnoses and treatments as electronic medical sheet data in recording media such as optical disks, magnetic disks or the like.

Further, in the medical institutions, creation of receipts is also performed based on the contents of medical sheets. Here, receipts refer to medical fee detailed statements in which medical services in health care services provided by health insurance and points and amounts of money relating thereto are written. The contents of receipts are examined by examination and payment facilities such as Social Insurance Medical Fee Payment Fund or National Health Insurance Organization or the like. When the contents of receipts are approved as being appropriate, the amounts of money written in the receipts are paid to medical institutions.

However, receipts have often been returned or assessed because of defective entries in disease/injury name fields and outcome fields in medical sheets. Since there are limits for contents that can be entered in medical sheets at the time of consultations of patients, and adjustment of disease/injury name fields and entries in outcome fields are often performed at timing after considerable time has passed from the last consultations with the patients, lack of adjustment and omission of entries have been caused. Further, although many outpatients do not visit hospitals after their diseases and injuries are healed because of the diseases or injuries, it is necessary to confirm those patients' circumstances for completing receipts, complicated works have been performed in which medical sheets are opened one by one and contents therein are confirmed or complemented.

As a related technology, Japanese Patent Application Publication JP-P2003-122843A discloses a medical accounting system capable of reducing burdens on medical accounting operators by simplifying operation, and preventing overcharges and omissions of charges in medical accounting (pages 1 and 7, FIG. 7). In this medical accounting system, a name of disease of a patient, which has not been outcome-processed, is retrieved, and if no effective name of disease is registered, the fact that the name of disease at the initial visit has not been entered is displayed on the screen. On the other hand, if an effective name of disease is registered, it is judged whether or not start dates of all effective names of disease are one month or more before that day. If start dates of all effective names of disease are one month or more before that day, it is determined whether or not one month or more has been elapsed after the last visit date. If one month or more has been elapsed after the last visit date, a message is displayed which informs that all effective names of disease are outcome-processed. However, JP-P2003-122843A does not disclose the support of entries in outcome fields.

### SUMMARY OF THE INVENTION

The present invention has been achieved in view of the above-described problems. An object of the present invention is to automate or semi-automate entries into outcome fields in electronic medical sheets and prompt adjustment of disease/injury name fields in a medical information management apparatus for managing contents of diagnoses and treatments as electronic medical sheet data.

In order to solve the above-described problems, a medical information management apparatus according to the present invention is a medical information management apparatus for managing contents of diagnoses and treatments as electronic medical sheet data in a medical institution, and the apparatus includes: a recording medium in which a database for accumulating electronic medical sheet data of plural cases is recorded; automatic outcome processing means for retrieving electronic medical sheet data of at least one case in the database and adding outcome field data and/or end date data to the retrieved electronic medical sheet data in the case where set condition is satisfied; display data generating means for generating display data for displaying contents of medical sheets of respective cases based on the electronic medical sheet data of the plural cases accumulated in the database; and a display unit for displaying the contents of the medical sheets based on the display data generated by the display data generating means.

Further, a medical information management method according to the present invention is a medical information management method to be used in a medical information management apparatus for managing contents of diagnoses and treatments as electronic medical sheet data in a medical institution, and the method includes the steps of: (a) retrieving electronic medical sheet data of at least one case in a database for accumulating electronic medical sheet data of plural cases; and (b) adding outcome field data and/or end date data to the retrieved electronic medical sheet data in the case where set condition is satisfied.

Furthermore, a medical information management program according to the present invention is a medical information management program to be used in a medical information management apparatus for managing contents of diagnoses and treatments as electronic medical sheet data in a medical institution, and the program actuates a CPU to execute the procedures of: (a) retrieving electronic medical sheet data of at least one case in a database for accumulating electronic medical sheet data of plural cases; and (b) adding outcome field data and/or end date data to the retrieved electronic medical sheet data in the case where set condition is satisfied.

In the above, outcome field data and/or end date data may be added to the retrieved electronic medical sheet data and the display unit may be caused to display the contents of the medical sheets so as to prompt confirmation of an outcome field and/or adjustment of a disease/injury name field in the case where a second set condition is satisfied.

### BRIEF DESCRIPTION OF THE DRAWINGS

FIG. 1 is a schematic diagram showing a medical information management system including a medical information management apparatus according to one embodiment of the present invention;

FIG. 2 is a block diagram showing the constitution of an electronic medical sheet management terminal included in the medical information management apparatus according to the one embodiment of the present invention;

FIG. 3 shows a part of contents of a medical sheet; and

FIG. 4 is a flowchart showing an example of the operation of the medical information management apparatus according to the one embodiment of the present invention.

### DESCRIPTION OF THE PREFERRED EMBODIMENTS

Hereinafter, a preferred embodiment of the present invention will be described in detail by referring to the drawings. The same reference numerals are assigned to the same component elements and the description thereof will be omitted.

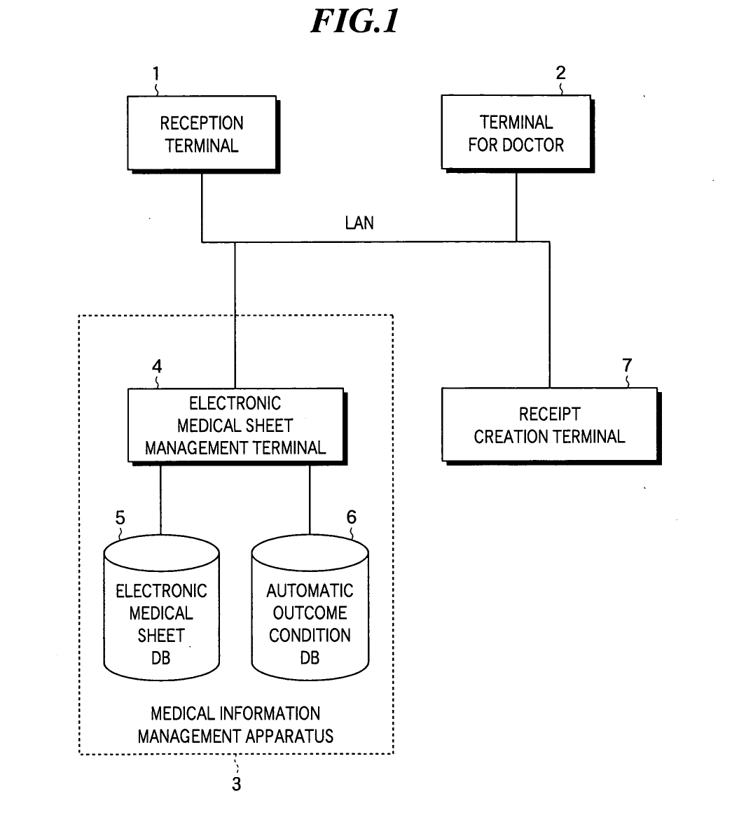

FIG. 1 is a schematic diagram showing a medical information management system including a medical information management apparatus according to one embodiment of the present invention. As shown in FIG. 1, this medical information management system includes a reception terminal 1 to be used at the time of reception of patients, a terminal for doctor 2 to be used by a doctor for entering contents of diagnoses and treatments, a medical information management apparatus 3 for managing medical information, and a receipt creation terminal 7 for generating receipts, which are connected via a LAN (local area network) in a medical institution such as a clinic or a general hospital.

The medical information management apparatus 3 includes an electronic medical sheet management terminal 4 for managing contents of diagnoses and treatments as electronic medical sheet data, a recording medium in which an electronic medical sheet database (DB) 5 for accumulating electronic medical sheet data of plural cases is recorded, and a recording medium in which an automatic outcome condition database (DB) 6 for storing automatic outcome condition to be used in an automatic outcome function is recorded. By the way, the receipt creation terminal 7 may be omitted by additionally providing a function for generating receipts to the electronic medical sheet management terminal 4.

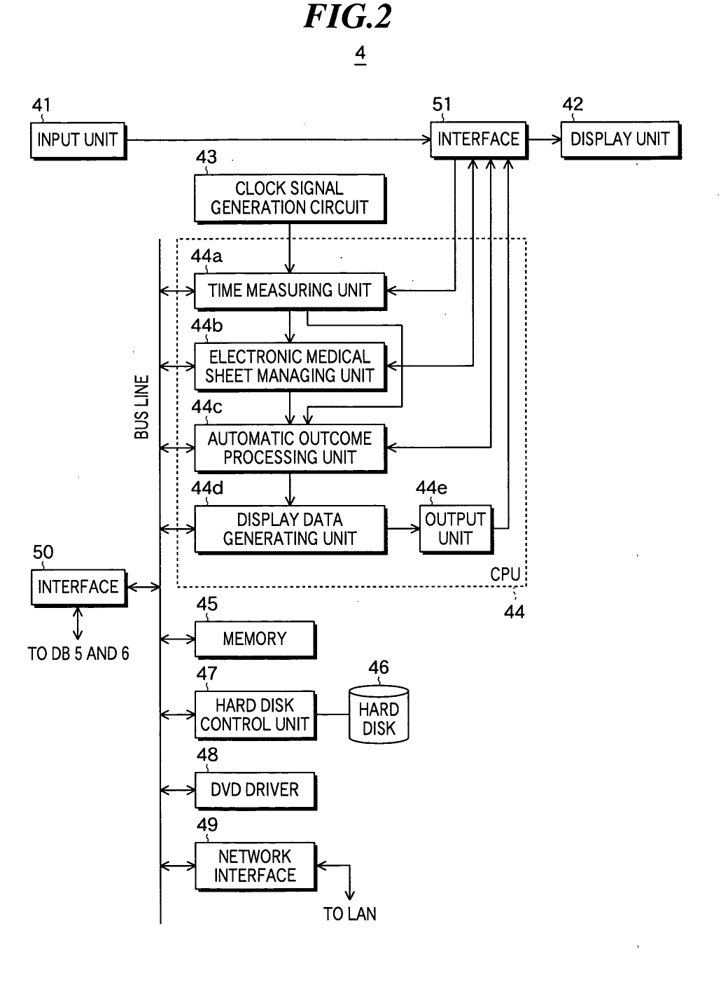

FIG. 2 is a block diagram showing the constitution of an electronic medical sheet management terminal included in the medical information management apparatus according to the one embodiment of the present invention. The electronic medical sheet management terminal 4 includes an input unit 41 to be used for inputting various kinds of instructions etc., a display unit 42 such as a CRT or LCD display for displaying images for operation etc., a clock signal generation circuit 43 for generating a clock signal for time measurement, a central processing unit (hereinafter, referred to as CPU) 44 to which the input unit 41 and the display unit 42 are connected via an interface 51, a memory 45, a hard disk 46, a hard disk control unit 47 for controlling writing and reading of data in the hard disk 46, a DVD drive 48 for performing writing and reading of data on a DVD (digital versatile disk), a network interface 49 for connection to a LAN, and an interface 50 for access to the electronic medical sheet database (DB) 5 and automatic outcome condition database (DB) 6. These parts 44 to 50 are connected to each others via a bus line.

In the hard disk 46, software (program) for actuating the CPU 44 to perform operation is recorded. As the recording medium for recording the program, not only the built-in hard disk 46, but also a DVD-ROM, a CD-ROM, an external hard disk, a flexible disk, an MO, an MT, a RAM and so on may be used.

Next, function blocks 44a to 44e formed by the CPU 44 and the software (program) will be described.

The time measuring unit 44a measures time by counting the clock signal for time measurement supplied from the clock signal generation circuit 43. In addition, the time measuring unit 44a may measure time by using a network time server or the like.

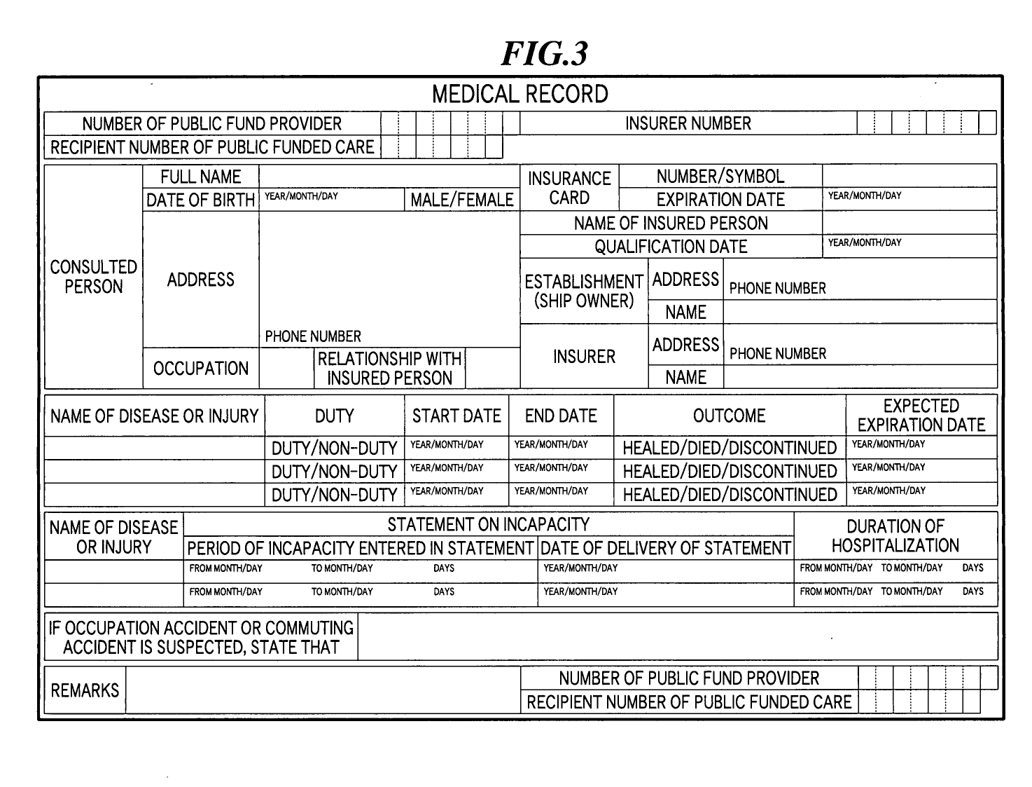

The electronic medical sheet managing unit 44b manages electronic medical sheet data of plural cases stored in the electronic medical sheet database 5. FIG. 3 shows a part of contents of a medical sheet. As shown in FIG. 3, in the medical sheet, number of public fund provider, recipient number of public funded care, insurer number, insurance card number/symbol and so on are included as items required to be entered on insurance medical institution's responsibility. Further, name of disease or injury (disease/injury name), start date, end date, outcome and so on are included as items required to be entered on insurance doctor's responsibility. As a content of outcome, one is selected from “healed”, “died” and “discontinued”.

However, there are limits for contents that can be entered in medical sheets at the time of consultations of patients, and adjustment of disease/injury name fields and entries in outcome fields are often performed at timing after considerable time has passed from the last consultations with the patients. Therefore, lack of adjustment and omission of entries have been caused. As a result, receipts have often been returned or assessed because of defective entries in disease/injury name fields and outcome fields in medical sheets.

Accordingly, in the embodiment, the automatic outcome processing unit 44c regularly searches the electronic medical sheet database 5 and refers to the time measured by the time measuring unit 44a so as to automatically or semi-automatically performs diagnosis completing processing as to the name of disease or injury with respect to a case that has not been updated for a predetermined period after the data of the disease/injury name field is stored. Here, the diagnosis completing processing includes one or some of entry of the end date, entry in the outcome field, display of medical sheet contents for adjustment of the disease/injury name field, etc.

The entry of end date is performed by referring to the time measured by the time measuring unit 44a, adding thus obtained data of date to the electronic medical sheet data of the case. The entry in the outcome field is performed by selecting one of “healed”, “died” and “discontinued”, and adding data representing the selected one to the electronic medical sheet data of the case. The name of disease or injury includes a standard name of disease or injury and a classification code of diseases such as ICD-10, etc. The adjustment of disease/injury name field is performed, when the disease/injury name field is changed or added, by adding finally determined one or some names of disease or injury to the electronic medical sheet data.

In the case of performing automatic outcome processing, the automatic outcome processing unit 44c refers to the automatic outcome condition database 6 and automatically selects one of “healed”, “died” and “discontinued” according to condition corresponding to plural names of disease or injury stored in the automatic outcome condition database 6. As such condition, detailed criteria have been set in advance by an insurance doctor or as default. Thus, omission of entries in outcome fields can be prevented and adjustment of names of disease or injury can be prompted. By the way, in the case where detailed criteria are set by default, they are desirably confirmed by an insurance doctor.

In the automatic outcome condition database 6, detailed criteria for entries in the outcome fields, the content of outcome (one of “healed”, “died” and “discontinued”) to be entered when respective criteria for entries are satisfied, and condition or setting as to whether automatic outcome processing or semi-automatic outcome processing is performed are stored corresponding to plural names of disease or injury. For example, regarding the name of disease or injury “common cold”, after a period of one week has passed in addition to dosing days of medication, the content “healed” in the outcome field is selected, and the processing unit is set to perform not the semi-automatic outcome processing but the automatic outcome processing.

On the other hand, in the case of performing the semi-automatic outcome processing, the automatic outcome processing unit 44c causes the display unit 42 to display the contents of the medical sheet when performing the above-mentioned automatic outcome processing so as to call the insurance doctor's attention in correspondence with the name of disease or injury and receive a confirmation of the insurance doctor. The insurance doctor can change the displayed type of outcome and adjust the name of disease or injury by operating the input unit 41. Thus, omission of entries in the outcome fields can be prevented and adjustment of the names of disease or injury can be prompted.

Alternatively, in the case where data representing that a patient of any one case visits the medical institution because of another disease or injury is inputted, the automatic outcome processing unit 44c may retrieve electronic medical sheet data of that case in the electronic medical sheet database 5. In the case where the set condition is satisfied, the automatic outcome processing unit 44c adds outcome field data and/or end date data to electronic medical sheet data of that case, and causes the display unit 42 to display the contents of the medical sheet of that case so as to prompt confirmation of outcome field and/or adjustment of disease/injury name field.

Alternatively, the automatic outcome processing unit 44c may retrieve electronic medical sheet data with respect to plural cases having the same data in at least one field in the electronic medical sheet database 5. In the case where the set condition is satisfied, the automatic outcome processing unit 44c adds outcome field data and/or end date data to electronic medical sheet data of the plural cases, and causes the display unit 42 to display a patient list of the plural cases including end date data and/or contents of outcome field so as to prompt the confirmation of outcome field and/or adjustment of disease/injury name field.

The display data generating unit 44d generates, based on electronic medical sheet data of plural cases accumulated in the electronic medical sheet database 5, display data for displaying contents of medical sheets of the respective cases. The display data generated by the display data generating unit 44d is outputted to the display unit 42 via the output unit 44e and interface 51, and the contents of the medical sheets of the respective cases are displayed in the display unit 42 so that the contents of the medical sheets are confirmed by the insurance doctor. Further, the electronic medical sheet data that has been subjected to outcome processing and so on are stored in the electronic medical sheet database 5 again.

Next, the operation of the medical information management apparatus according to the embodiment will be described by referring to FIGS. 1-4.

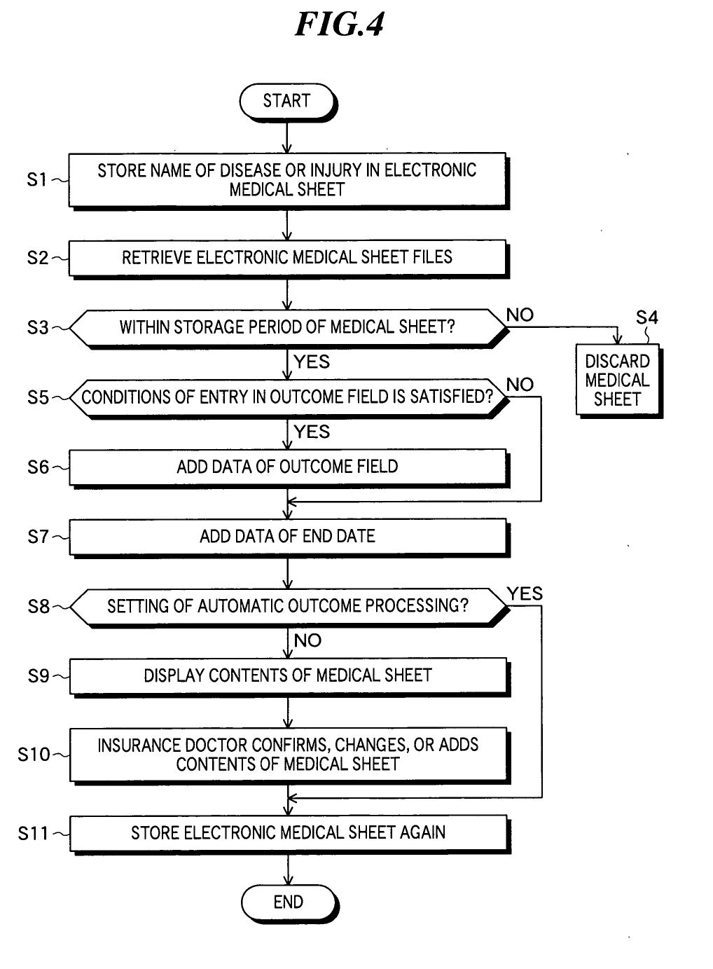

FIG. 4 is a flowchart showing an example of the operation of the medical information management apparatus according to the embodiment.

When an operator inputs information on a new patient by using the reception terminal 1, the terminal for doctor 2, or the electronic medical sheet management terminal 4, the electronic medical sheet managing unit 44b of the electronic medical sheet management terminal 4 generates electronic medical sheet data of a new case.

When an insurance doctor inputs the name of disease or injury of the patient by using the terminal for doctor 2 or the electronic medical sheet management terminal 4, the electronic medical sheet managing unit 44b of the electronic medical sheet management terminal 4 opens an electronic medical sheet file of the new case and stores the name of disease or injury at step S1. Alternatively, when consultation or treatment is given with respect to another disease or injury of the patient who has already visited the medical institution, the electronic medical sheet managing unit 44b opens an electronic medical sheet file of a past case of the patient, and adds and stores a new name of disease or injury at step S1.

At step S2, the automatic outcome processing unit 44c of the electronic medical sheet management terminal 4 regularly retrieves electronic medical sheet files stored in the electronic medical sheet database 5. At step S3, the automatic outcome processing unit 44c determines, with respect to the respective electronic medical sheet files, whether or not a storage period of the medical sheet is expired. The electronic medical sheet file having expired storage period is discarded at step S4.

At step S5, the automatic outcome processing unit 44c determines, with respect to electronic medical sheet data that has not been updated for a predetermined period after the data of the disease/injury name field is stored, whether or not the condition set in the automatic outcome condition database 6 is satisfied by referring to the time measured by the time measuring unit 44a, for example. If the set condition is satisfied, the automatic outcome processing unit 44c performs entry in the outcome field by adding data of outcome field to the electronic medical sheet data of the case at step S6.

Here, condition for performing entry in the outcome field can be weighted according to the period from the name of disease and injury is stored in the electronic medical sheet data of the case until now, or the name of disease or injury and the degree of severity. Further, the date of performing entry in the outcome field may be adjusted according to the cutoff date for claiming premium in the medical accounting. For example, the condition is set so that the automatic outcome processing may be performed when the date is X days before the initial reference date, and the semi-automatic outcome processing may be performed when the date is further Y days before the date.

Alternatively, the condition for performing entry in the outcome field may be set for combinations of plural names of disease or injury. In this case, it is desirable that some groups are formed by combinations of main names of disease or injury and sub names of disease or injury, and condition for performing entry in the outcome field may be set for the respective groups.

Further, when the condition for performing entry in the outcome field is set, a candidate of the condition to be set may be presented by changing candidates of the condition in correspondence with frequencies of appearance of names of disease or injury. For example, the automatic outcome processing is presented for general names of disease or injury, while the semi-automatic outcome processing, in which confirmation by an insurance doctor is performed, is presented for rare names of disease or injury. Here, the frequencies of appearance of names of disease or injury may be learned and a candidate of the condition: to be set may be presented by changing candidates of the condition. For this purpose, it is effective to take statistic of frequencies of appearance of names of disease or injury in the medical institution, and to take statistic of frequencies of appearance of names of disease or injury in the area where the medical institution performs medical coordination, in the area where the medical institution exist or in the entire country.

At step S7, the automatic outcome processing unit 44c enters the end date by adding end date data to the electronic medical sheet data of the case. Then, at step S8, the automatic outcome processing unit 44c determines whether or not setting of the automatic outcome processing have been made with respect to the case. In the case where the setting of the automatic outcome processing has been made, the process moves to step S11.

If the setting of the automatic outcome processing has not been made, that is, setting of the semi-automatic outcome processing has been made, the automatic outcome processing unit 44c causes the display unit 42 to display contents of the medical sheet at step S9. At step S10, the insurance doctor can confirm or change the displayed types of outcome and adjust the name of disease or injury by confirming or changing contents of the medical sheet or adding any content to the medical sheet by operating the input unit 41. At step S11, the automatic outcome processing unit 44c stores the electronic medical sheet data of the case in the electronic medical sheet database 5 again and closes the electronic medical sheet file of the case.

Note that, after entries of outcome and adjustment of names of disease or injury are finished with respect to all names of disease or injury in one case, the electronic medical sheet managing unit 44b may perform the accompanying processing as below. For example, the electronic medical sheet managing unit 44b performs settlement processing on the electronic medical sheet data of the case, and moves the electronic medical sheet data from the electronic medical sheet database 5 to another recording medium. As the other recording medium, a portable DVD, a large-scaled file system, a recording medium of a data center connected via a network such as Internet are applicable. Alternatively, the electronic medical sheet managing unit 44b may perform encryption processing or compression processing on the electronic medical sheet data of the case.

As described above, according to the present invention, electronic medical sheet data of at least one case is retrieved in a database for accumulating electronic medical sheet data of plural cases, and entry in an outcome field in the electronic medical sheet can be automated by adding outcome field data and/or end date data to the electronic medical sheet data of the retrieved case when set condition is satisfied. Alternatively, entry in outcome field in the electronic medical sheet can be semi-automated and a doctor can be prompted to adjust a disease/injury name field by adding outcome field data and/or end date data to the electronic medical sheet data of the retrieved case and causing the display unit to display the contents of the medical sheet of the case when a second set condition is satisfied.

1. A medical information management apparatus for managing contents of diagnoses and treatments as electronic medical sheet data in a medical institution, said apparatus comprising:
a recording medium in which a database for accumulating electronic medical sheet data of plural cases is recorded;
automatic outcome processing means for retrieving electronic medical sheet data of at least one case in said database and adding outcome field data and/or end date data to the retrieved electronic medical sheet data in the case where set condition is satisfied;
display data generating means for generating display data for displaying contents of medical sheets of respective cases based on the electronic medical sheet data of the plural cases accumulated in said database; and
a display unit for displaying the contents of the medical sheets based on the display data generated by said display data generating means.

2. The medical information management apparatus according to claim 1, wherein said automatic outcome processing means adds outcome field data and/or end date data to the retrieved electronic medical sheet data and causes said display unit to display contents of a medical sheet of the retrieved at least one case so as to prompt confirmation of an outcome field and/or adjustment of a disease/injury name field in the case where a second set condition is satisfied.

3. The medical information management apparatus according to claim 1, wherein said automatic outcome processing means refers time measured by time measuring means and thereby adds outcome field data and/or end date data to electronic medical sheet data with respect to a case, which has not been updated for a predetermined period after data of a disease/injury name field is stored, in the case where set condition is satisfied.

4. The medical information management apparatus according to claim 1, wherein said automatic outcome processing means retrieves, when data representing that a patient of any one of said plural cases visits the medical institution because of another disease/injury is inputted, electronic medical sheet data of that case in said database, and adds outcome field data and/or end date data to the retrieved electronic medical sheet data and causes said display unit to display contents of a medical sheet of that case so as to prompt confirmation of an outcome field and/or adjustment of a disease/injury name field in the case where set condition is satisfied.

5. The medical information management apparatus according to claim 1, wherein said automatic outcome processing means retrieves electronic medical sheet data of plural cases having same data in at least one field in said database, and adds outcome field data and/or end date data to the retrieved electronic medical sheet data and causes said display unit to display a patient list of the retrieved plural cases including end date and/or contents of an outcome field so as to prompt confirmation of the outcome field and/or adjustment of a disease/injury name field in the case where set condition is satisfied.

6. The medical information management apparatus according to claim 1, wherein said medical information management apparatus generates receipt data representing medical services in health care services provided by health insurance and points and amounts of money relating thereto.

7. A medical information management method to be used in a medical information management apparatus for managing contents of diagnoses and treatments as electronic medical sheet data in a medical institution, said method comprising the steps of:
(a) retrieving electronic medical sheet data of at least one case in a database for accumulating electronic medical sheet data of plural cases; and
(b) adding outcome field data and/or end date data to the retrieved electronic medical sheet data in the case where set condition is satisfied.

8. The medical information management method according to claim 7, further comprising the step of:
(c) causing a display unit to display contents of a medical sheet of the retrieved at least one case so as to prompt confirmation of an outcome field and/or adjustment of a disease/injury name field in the case where a second set condition is satisfied.

9. The medical information management method according to claim 7, wherein step (b) includes referring time measured by time measuring means and thereby adding outcome field data and/or end date data to electronic medical sheet data with respect to a case, which has not been updated for a predetermined period after data of a disease/injury name field is stored, in the case where set condition is satisfied.

10. The medical information management method according to claim 7, wherein step (a) includes retrieving, when data representing that a patient of any one of said plural cases visits the medical institution because of another disease/injury is inputted, electronic medical sheet data of that case in said database; and
step (b) includes adding outcome field data and/or end date data to the retrieved electronic medical sheet data and causing a display unit to display contents of a medical sheet of that case so as to prompt confirmation of an outcome field and/or adjustment of a disease/injury name field in the case where set condition is satisfied.

11. The medical information management method according to claim 7, wherein step (a) includes retrieving electronic medical sheet data of plural cases having same data in at least one field in said database; and
step (b) includes adding outcome field data and/or end date data to the retrieved electronic medical sheet data and causing a display unit to display a patient list of the retrieved plural cases including end date and/or contents of an outcome field so as to prompt confirmation of the outcome field and/or adjustment of a disease/injury name field in the case where set condition is satisfied.

12. A medical information management program to be used in a medical information management apparatus for managing contents of diagnoses and treatments as electronic medical sheet data in a medical institution, said program actuating a CPU to execute the procedures of:
(a) retrieving electronic medical sheet data of at least one case in a database for accumulating electronic medical sheet data of plural cases; and
(b) adding outcome field data and/or end date data to the retrieved electronic medical sheet data in the case where set condition is satisfied.

13. The medical information management program according to claim 12, further actuating the CPU to execute the procedure of:
(c) causing a display unit to display contents of a medical sheet of the retrieved at least one case so as to prompt confirmation of an outcome field and/or adjustment of a disease/injury name field in the case where a second set condition is satisfied.

14. The medical information management program according to claim 12, wherein procedure (b) includes referring time measured by time measuring means and thereby adding outcome field data and/or end date data to electronic medical sheet data with respect to a case, which has not been updated for a predetermined period after data of a disease/injury name field is stored, in the case where set condition is satisfied.

15. The medical information management program according to claim 12, wherein procedure (a) includes retrieving, when data representing that a patient of any one of said plural cases visits the medical institution because of another disease/injury is inputted, electronic medical sheet data of that case in said database; and
procedure (b) includes adding outcome field data and/or end date data to the retrieved electronic medical sheet data and causing a display unit to display contents of a medical sheet of that case so as to prompt confirmation of an outcome field and/or adjustment of a disease/injury name field in the case where set condition is satisfied.

16. The medical information management program according to claim 12, wherein procedure (a) includes retrieving electronic medical sheet data of plural cases having same data in at least one field in said database, and
procedure (b) includes adding outcome field data and/or end date data to the retrieved electronic medical sheet data and causing a display unit to display a patient list of the retrieved plural cases including end date and/or contents of an outcome field so as to prompt confirmation of the outcome field and/or adjustment of a disease/injury name field in the case where set condition is satisfied.
